(19) United States
(12) Patent Application Publication
(10) Pub. No.: US 2024/0401391 A1
(43) Pub. Date: Dec. 5, 2024

(54) SLIDING DOOR DEVICE FOR VEHICLE

(71) Applicants: Hyundai Motor Company, Seoul (KR); Kia Corporation, Seoul (KR)

(72) Inventors: Gookhyun JEON, Seoul (KR); Jaeseung LEE, Hwaseong-Si (KR)

(73) Assignees: Hyundai Motor Company, Seoul (KR); Kia Corporation, Seoul (KR)

(21) Appl. No.: 18/379,581

(22) Filed: Oct. 12, 2023

(30) Foreign Application Priority Data
Jun. 5, 2023 (KR) 10-2023-0072253

(51) Int. Cl. E05D 15/06; E05D 15/10

(52) U.S. Cl. CPC E05D 15/0678; E05D 15/1081; E05Y 2201/628; E05Y 2900/531

(57) ABSTRACT

A sliding door device for a vehicle includes: a door for opening and closing a door opening portion formed in a vehicle body; a door arm including a first end portion connected to an internal side of the door and a second end portion movably engaged to a rail extending in a longitudinal direction of the vehicle body; a ball bearing assembly provided at the second end portion of the door arm and moving along a path formed by the rail; and a wheel bearing rotatably provided on an external circumferential surface of the ball bearing assembly and rolling while being in contact with side walls of the rail.

### CROSS-REFERENCE TO RELATED APPLICATION

The present application claims priority to Korean Patent Application No. 10-2023-0072253 filed on Jun. 5, 2023, the entire contents of which is incorporated herein for all purposes by this reference.

### BACKGROUND OF THE PRESENT DISCLOSURE

### Field of the Present Disclosure

The present disclosure relates to a sliding door device for a vehicle, and more particularly, to a sliding door device for a vehicle that opens or closes a door opening portion of a vehicle body by sliding back and forth in a longitudinal direction of the vehicle.

### Description of Related Art

In general, a vehicle has a compartment having a predetermined size and into which a driver or an accompanying passenger may get, and compartment doors are provided on a vehicle body to open or close the compartment.

In a case of a passenger vehicle, the compartment doors include a front door provided on the front side of the vehicle in a longitudinal direction and a rear door provided on the rear side of the vehicle in the longitudinal direction, and the front door and the rear door are usually rotatably provided on the vehicle body by hinges.

In a case of a van in which many people may ride, the compartment door opens or closes the compartment while sliding back and forth in the longitudinal direction of the vehicle.

The sliding compartment door of the van moves backward in the longitudinal direction of the vehicle to open the compartment, and moves forward in the longitudinal direction of the vehicle to close the compartment. Therefore, the sliding compartment door needs a smaller space for opening and closing the compartment as compared with the hinged compartment door of the passenger vehicle, and a door opening portion formed in the vehicle body may thus be completely opened even with a narrow space for opening and closing the compartment.

However, as illustrated in FIG. 1A, FIG. 1B, FIG. 1C, and FIG. 1D, in a sliding compartment door according to the related art, a roller arm bracket 1 coupled to a door arm 4 includes a guide bearing 3 and a rod bearing 2 that are in contact with a rail 5 and roll along the rail 5. The guide bearing 3 guides movement of the door arm 4 over the rail 5, and the rod bearing 2 serves to support a load applied to a door 8 and the door arm 4.

There is no major problem in a case where the door 8 linearly moves in a longitudinal direction of a vehicle body as illustrated in FIG. 2A. However, in a case of FIG. 2B where the roller arm bracket 1 curvedly moves for a pop-up of the door 8, the roller arm bracket 1 needs to rotate around a roller arm rotation shaft 6, and noise occurs due to friction and slip between the rod bearing 2 and a side wall of the rail 5. Furthermore, as at least two guide bearings 3 are required to implement a curved movement trajectory, the configuration becomes complicated and the size increases, which is disadvantageous in packaging.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a ball bearing assembly including a ball bearing and a wheel bearing that roll along a rail to a door arm, achieving size reduction and solving a noise problem caused by friction and slip.

A sliding door device for a vehicle according to an exemplary embodiment of the present disclosure includes: a door for opening and closing a door opening portion formed in a vehicle body; a door arm including a first end portion connected to an internal side of the door and a second end portion movably engaged to a rail extending in a longitudinal direction of the vehicle body; a ball bearing assembly provided at the second end portion of the door arm and moving along a path formed by the rail; and a wheel bearing rotatably provided on an external circumferential surface of the ball bearing assembly and rolling while being in contact with side walls of the rail.

The ball bearing assembly may include: a shaft coupled to a lower portion of the other end portion of the door arm and extending toward a bottom wall of the rail; a case coupled to a lower end portion of the shaft; and a main ball bearing protruding from a lower end portion of the case and rolling along the path formed by the upper rail while being in contact with the bottom wall of the rail.

The door arm may be connected to the shaft of the ball bearing assembly by riveting or screwing.

The ball bearing assembly may further include a damper coupled to the lower end portion of the shaft inside the case and absorbing a shock transferred from the bottom wall of the rail.

The ball bearing assembly may further include auxiliary ball bearings provided around the damper inside the case, transferring a load of the door to the damper, and rotating while being in contact with the main ball bearing to rotate the main ball bearing.

The shaft and the case may be integrated with each other.

The case may include a stepped external circumferential surface.

The wheel bearing may include: an internal ring fixedly coupled to an external circumferential surface of the case; an external ring spaced from the internal ring at a predetermined interval outside the internal ring, rotating around the internal ring, and rolling along the side walls of the rail; and retaining ball bearings provided between the internal ring and the external ring so that the internal ring and the external ring are spaced from each other at the predetermined interval, and rotating while being in contact with the external ring to rotate the external ring.

The wheel bearing may further include an external tire attached to an external circumferential surface of the external ring.

The external tire of the wheel bearing may roll while being in contact with the side walls of the rail.

The wheel bearing may further include a retainer defining positions of the retaining ball bearings between the internal ring and the external ring.

The wheel bearing may further include upper and lower shields covering upper and lower surfaces of the internal ring and the external ring in a direction perpendicular to the side walls of the rail.

The rail may include an upper rail extending in the longitudinal direction of the vehicle body and a lower rail disposed below the upper rail, the ball bearing assembly may move along an upper surface of the lower rail, and the wheel bearing may roll while being in contact with side walls of the upper rail.

The other end portion of the door arm may be coupled to the ball bearing assembly between the upper rail and the lower rail.

The ball bearing assembly may include: a shaft coupled to an upper portion of the door arm and extending toward the upper rail; a case coupled to a lower end portion of the shaft; and a main ball bearing protruding from a lower end portion of the case and rolling along the path formed by the rail while being in contact with the upper surface of the lower rail.

The lower end portion of the shaft may be formed as a male screw, an upper end portion of the case may be formed as a female screw, the shaft and the case may be screwed, and the other end portion of the door arm may be interposed and coupled between the lower end portion of the shaft and the upper end portion of the case.

According to an exemplary embodiment of the present disclosure, an existing door arm opening and closing structure using at least three bearings applied to a door arm is improved with a structure in which a wheel bearing and a ball bearing assembly are integrated, achieving size reduction and structure simplification.

Furthermore, as the ball bearing that rolls along the bottom wall of the rail is applied, it is possible to reduce noise caused by friction and slip in a curved section.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1A, FIG. 1B, FIG. 1C, and FIG. 1D are views exemplarily illustrating a bearing structure applied to a door arm in an existing door opening and closing structure;

FIG. 2A and FIG. 2B are views exemplarily illustrating movement of bearings in a straight section and a curved section in the existing door opening and closing structure;

FIG. 3 is a view schematically illustrating a sliding door device for a vehicle according to an exemplary embodiment of the present disclosure;

FIG. 4 is an enlarged view of “A” and “B” parts of FIG. 3;

FIG. 5 is a view exemplarily illustrating a state viewed from the front in FIG. 4;

FIG. 6 is a view exemplarily illustrating a ball bearing assembly of the sliding door device for a vehicle according to an exemplary embodiment of the present disclosure;

FIG. 7 is a view exemplarily illustrating an internal cross-sectional structure of the ball bearing assembly of the sliding door device for a vehicle according to an exemplary embodiment of the present disclosure;

FIG. 8 is a view exemplarily illustrating a wheel bearing of the sliding door device for a vehicle according to an exemplary embodiment of the present disclosure;

FIG. 9 is a view exemplarily illustrating a state in which the wheel bearing of the sliding door device for a vehicle according to an exemplary embodiment of the present disclosure is in contact with side walls of a rail as viewed from above;

FIG. 10 is an exploded view of the wheel bearing of the sliding door device for a vehicle according to an exemplary embodiment of the present disclosure;

FIG. 11A and FIG. 11B are views exemplarily illustrating a state in which the sliding door device for a vehicle moves in a straight section and a curved section according to an exemplary embodiment of the present disclosure;

FIG. 12 is a schematic view of a sliding door device for a vehicle according to another exemplary embodiment of the present disclosure; and

FIG. 13 is a view exemplarily illustrating a coupling structure of a ball bearing assembly of the sliding door device for a vehicle according to another exemplary embodiment of the present disclosure.

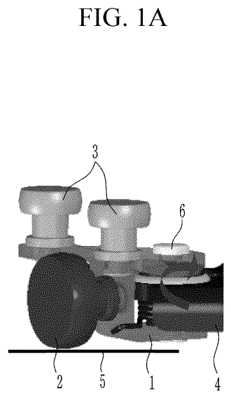

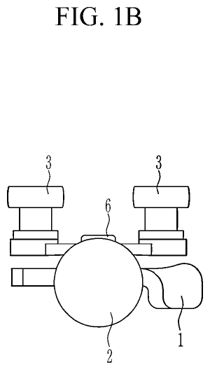

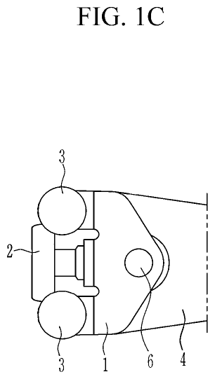

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings so that those skilled in the art to which the present disclosure pertains may easily practice the present disclosure. However, the present disclosure may be implemented in various different forms and is not limited to exemplary embodiments provided herein.

Furthermore, in several exemplary embodiments of the present disclosure, components including the same configuration will be representatively described using the same reference numerals in an exemplary embodiment of the present disclosure, and only components different from those of an exemplary embodiment will be described in the other exemplary embodiments of the present disclosure.

It is to be noted that the drawings are schematic and not drawn to scale. Relative dimensions and proportions of portions in the drawings are shown exaggerated or reduced in size for clarity and convenience in the drawings, and any dimensions are illustrative only and not limiting. Furthermore, the same reference numerals are used to indicate similar features in the same structure, element or part appearing in two or more drawings. When a part is referred to as being “on” another part, it may be directly on the another part or may have other parts intervening therebetween.

An exemplary embodiment of the present disclosure will be described in detail. As a result, various modifications of the exemplary embodiment are expected. Therefore, an exemplary embodiment of the present disclosure is not limited to a specific aspect of an illustrated region, and for example, includes modifications made for manufacturing.

Hereinafter, a structure of a sliding door device for a vehicle according to an exemplary embodiment of the present disclosure will be described in detail with reference to the accompanying drawings.

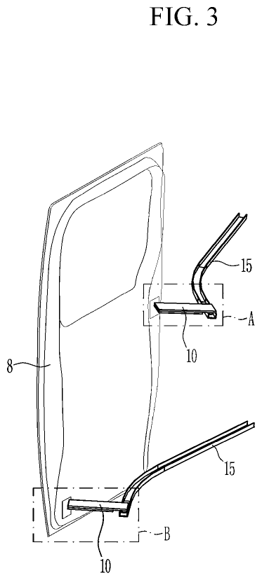

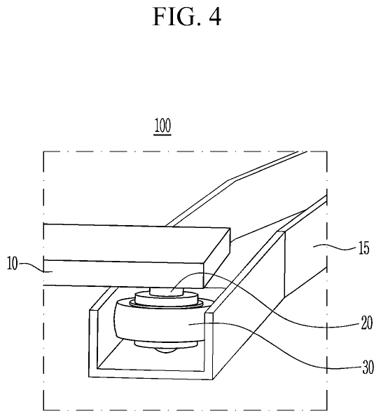

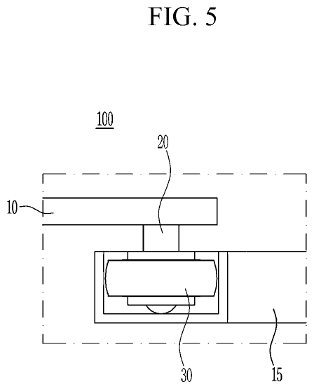

FIG. 3 is a view schematically illustrating the sliding door device for a vehicle according to an exemplary embodiment of the present disclosure. FIG. 4 is an enlarged view of “A” and “B” parts of FIG. 3. FIG. 5 is a view exemplarily illustrating a state viewed from the front in FIG. 4.

Referring to FIG. 3, FIG. 4, and FIG. 5, a sliding door device 100 for a vehicle according to an exemplary embodiment of the present disclosure includes a door 8, a door arm 10 including one end portion connected to an internal side of the door 8, a ball bearing assembly 20 provided at the other end portion of the door arm 10, and a wheel bearing 30 rotatably provided on an external circumferential surface of the ball bearing assembly 20.

One end portion of the door arm 10 is connected to the internal side of the door 8, and the other end portion of the door arm 10 is coupled to a rail 15. The rail 15 may extend in a longitudinal direction of a vehicle body and may be formed in a curved shape toward the outside of the vehicle body. As the door 8 slides toward a rear side of the vehicle body, the other end portion of the door arm 10 may move along the rail 15, so that the door 8 is opened while popping up to the outside thereof.

The ball bearing assembly 20 may be provided on a lower portion of the other end portion of the door arm 10. The door arm 10 may be connected to a shaft 22 of the ball bearing assembly 20 by riveting or screwing.

The ball bearing assembly 20 may roll while being in contact with the rail 15. The rail 15 may include a bottom wall and side walls extending in a vertical direction from opposite end portions of the bottom wall. The ball bearing assembly 20 is positioned in a groove-shaped space formed by the bottom wall and the side walls, and may thus move along a path formed by the rail 15 without being separated from the rail 15 to the outside thereof. Furthermore, the ball bearing assembly 20 may move while being in contact with the bottom wall of the rail 15.

The wheel bearing 30 may be provided on the external circumferential surface of the ball bearing assembly 20 in such a way as to be rotatable about the ball bearing assembly 20. Furthermore, the wheel bearing 30 may roll while being in contact with the side walls of the rail 15.

Therefore, as the other end portion of the door arm 10 moves, the ball bearing assembly 20 and the wheel bearing 30 connected to the other end portion move together, the ball bearing assembly 20 may roll while being in contact with the bottom wall of the rail 15, and the wheel bearing 30 may roll while being in contact with the side walls of the rail 15.

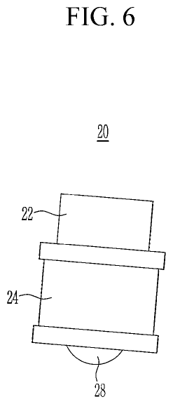

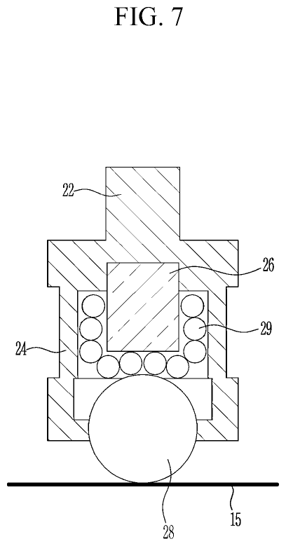

FIG. 6 is a view exemplarily illustrating the ball bearing assembly of the sliding door device for a vehicle according to an exemplary embodiment of the present disclosure. FIG. 7 is a view exemplarily illustrating an internal cross-sectional structure of the ball bearing assembly of the sliding door device for a vehicle according to an exemplary embodiment of the present disclosure.

As illustrated in FIG. 6, the ball bearing assembly 20 includes the shaft 22 coupled to the lower portion of the other end portion of the door arm 10 and extending toward the bottom wall of the rail 15, a case 24 coupled to a lower end portion of the shaft 22, and a main ball bearing 28 protruding from a lower end portion of the case 24.

The shaft 22 and the case 24 may be integrally formed and may each include a shape of cylinder. Furthermore, the case 24 may include a hollow inside, and the main ball bearing 28 may be disposed from the inside to the outside of the case 24. The main ball bearing 28 may be formed in a shape of a sphere and may roll along the path of the rail 15 while being in contact with the bottom wall of the rail 15.

The case 24 may include a stepped external circumferential surface. The wheel bearing 30 to be described below may be fitted onto the external circumferential surface of the case 24. As the wheel bearing 30 is coupled to the stepped external circumferential surface of the case 24, separation of the wheel bearing 30 from the case 24 may be prevented.

Referring to FIG. 7, the ball bearing assembly 20 may include a damper 26 coupled to the lower end portion of the shaft 22 inside the case 24 and absorbing a shock transferred from the bottom wall of the rail 15. The damper 26 may be implemented by an elastic member and may be formed of rubber.

Furthermore, a plurality of auxiliary ball bearings 29 may be provided inside the case 24. The auxiliary ball bearings 29 may be provided around the damper 26 and rotate while being in contact with the damper 26 and the main ball bearing 28. As the auxiliary ball bearings 29 rotate, the main ball bearing 28 may also rotate by rolling friction, and the auxiliary ball bearings 29 also serve to transfer a load of the door 8 to the damper 26. Furthermore, the damper 26 may absorb and disperse the load of the door 8 transferred from the main ball bearing 28 and the auxiliary ball bearings 29.

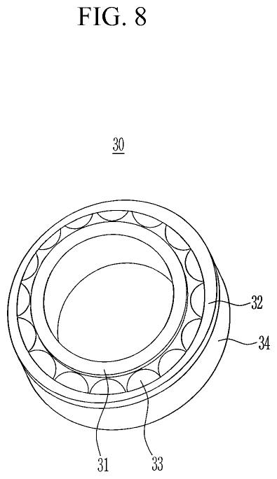

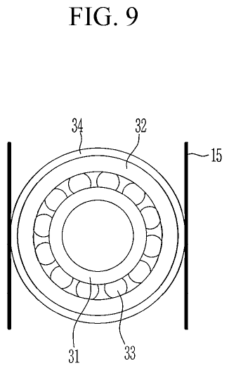

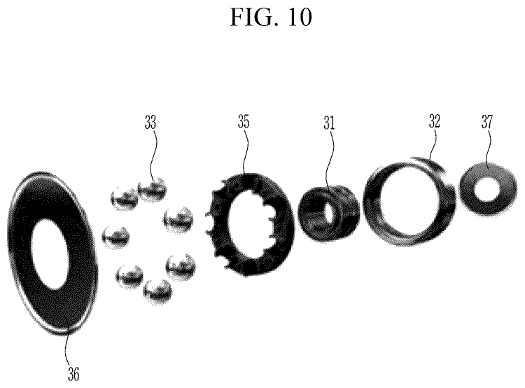

FIG. 8 is a view exemplarily illustrating the wheel bearing of the sliding door device for a vehicle according to an exemplary embodiment of the present disclosure. FIG. 9 is a view exemplarily illustrating a state in which the wheel bearing of the sliding door device for a vehicle according to an exemplary embodiment of the present disclosure is in contact with the side walls of the rail as viewed from above. FIG. 10 is an exploded view of the wheel bearing of the sliding door device for a vehicle according to an exemplary embodiment of the present disclosure.

As illustrated in FIG. 4, FIG. 5 and FIG. 6, the wheel bearing 30 may be fitted onto the stepped external circumferential surface of the case 24 of the ball bearing assembly 20, and roll on an internal side of the rail 15 while being in contact with the side walls of the rail 15.

As illustrated in FIG. 8 and FIG. 9, the wheel bearing 30 may be formed in an annular shape and may include an internal ring 31, an external ring 32, and retaining ball bearings 33.

The internal ring 31 may be fixedly coupled to the external circumferential surface of the case 24. The external ring 32 may be spaced from the internal ring 31 at a predetermined interval outside the internal ring 31, and may rotate around the internal ring 31. The external ring 32 may roll along the side walls of the rail 15.

The retaining ball bearings 33 may be provided between the internal ring 31 and the external ring 32. The number of retaining ball bearings 33 may be plural, and the plurality of retaining ball bearing 33 may be provided over the entire external circumferential surface of the internal ring 31 in such a way as to be in contact with the external circumferential surface of the internal ring 31 and an internal circumferential surface of the external ring 32. The retaining ball bearings 33 may rotate by themselves on the internal circumferential surface of the external ring 32 and rotate together as the external ring 32 rotates, so that the external ring 32 may rotate relative to the internal ring 31.

Meanwhile, an external tire 34 may be further provided on an external circumferential surface of the external ring 32. The external tire 34 may be formed of a rubber material, and may provide a frictional force in such a way as not to slip when the external tire 34 and the side walls of the rail 15 come into contact with each other. When the door 8 slides, the external tire 34 may roll along the path formed by the rail 15 while being in contact with the side walls of the rail 15.

As illustrated in FIG. 10, the wheel bearing 30 may further include a retainer 35 defining positions of the retaining ball bearings 33 between the internal ring 31 and the external ring 32. The retainer 35 may be fixedly coupled to the internal circumferential surface of the external ring 32, and a plurality of bearing seating points may be formed so that the retaining ball bearings 33 are inserted and exposed toward the internal ring 31.

Meanwhile, the wheel bearing 30 may further include upper and lower shields 36 and 37 covering upper and lower surfaces of the internal ring 31 and the external ring 32. The upper and lower shields 36 and 37 may keep step heights of the internal ring 31 and the external ring 32 the same and prevent the retaining ball bearings 33 from being separated from the retainer 35 to the outside thereof.

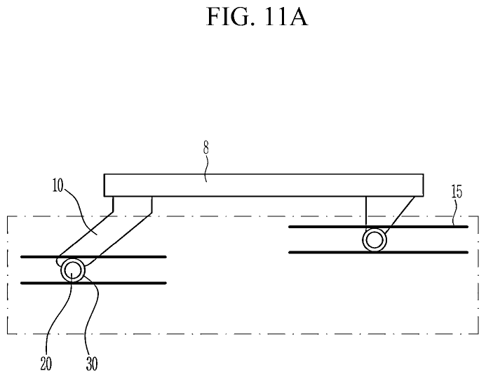

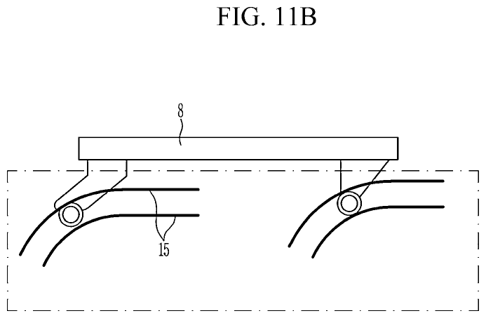

FIG. 11A and FIG. 11B are views exemplarily illustrating a state in which the sliding door device for a vehicle moves in a straight section and a curved section according to an exemplary embodiment of the present disclosure.

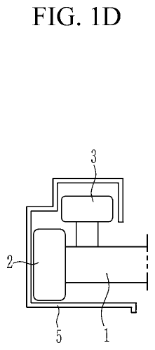

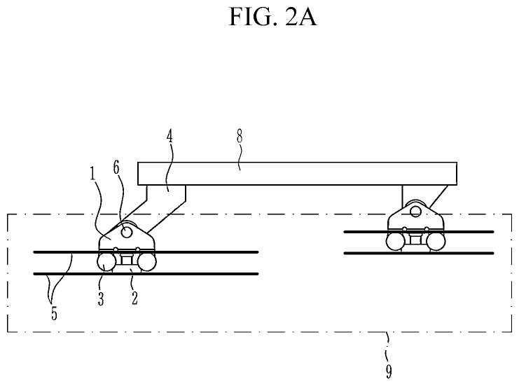

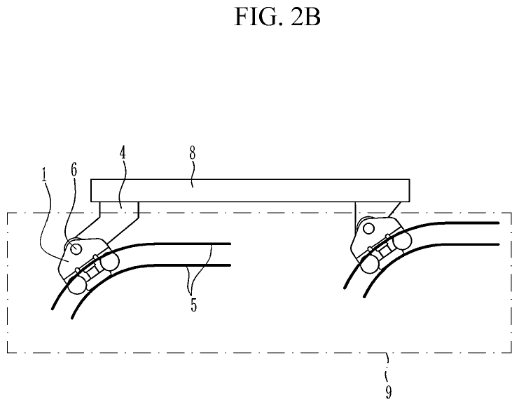

Compared to FIG. 2, the sliding door device for a vehicle according to an exemplary embodiment of the present disclosure does not include a separate guide bearing and a roller arm bracket, and a structure in which the ball bearing assembly 20 and the wheel bearing 30 are integrated may roll along the bottom wall and the side walls of the rail 15, and thus, it may be seen that the configuration is simple and the size is greatly reduced.

Furthermore, because a separate roller arm bracket and a rod bearing are not provided, noise due to friction and slip between the roller arm bracket and road bearing and the side walls of the rail 15 does not occur when the ball bearing assembly 20 moves along the curved section of the rail 15 for a pop-up of the door 8.

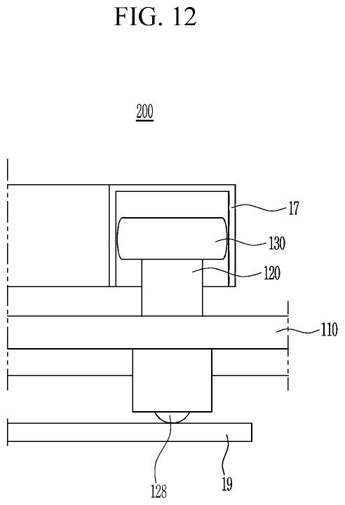

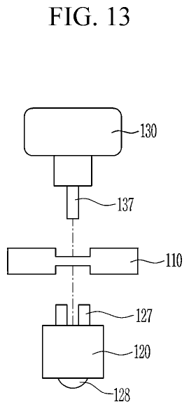

FIG. 12 is a schematic view of a sliding door device for a vehicle according to another exemplary embodiment of the present disclosure. FIG. 13 is a view exemplarily illustrating a coupling structure of a ball bearing assembly of the sliding door device for a vehicle according to another exemplary embodiment of the present disclosure.

Referring to FIG. 12, in a sliding door device 200 for a vehicle according to another exemplary embodiment of the present disclosure, rails may include an upper rail 17 and a lower rail 19. The upper rail 17 extends in the longitudinal direction of the vehicle body, and the lower rail 19 is disposed below the upper rail 17 in accordance with a path formed by the upper rail 17.

A ball bearing assembly 137, 120, 127, and 128 and a wheel bearing 130 are positioned between the upper rail 17 and the lower rail 19 and move along the paths formed by the rails 17 and 19. The ball bearing assembly 137, 120, 127, and 128 may move while being in contact with the lower rail 19. That is, a main ball bearing 128 of the ball bearing assembly may roll while being in contact with an upper surface of the lower rail 19. Furthermore, the wheel bearing 130 may move while being in contact with the upper rail 17. The upper rail 17 may have opposite side walls and an upper wall connecting the opposite side walls, and the wheel bearing 130 may roll while being in contact with the opposite side walls of the upper rail 17.

In an exemplary embodiment of the present disclosure, the lower rail 19 includes a flat wall on which the main ball bearing 128 of the ball bearing assembly may roll.

Furthermore, the other end portion of a door arm 110 may be coupled to the ball bearing assembly 137, 120, 127, and 128 between the upper rail 17 and the lower rail 19.

As illustrated in FIGS. 12 and 13, the ball bearing assembly includes a shaft 137, a case 120 coupled to a lower end portion of the shaft 137, and the main ball bearing 128 protruding from a lower end portion of the case 120 inside the case 120. The other end portion of the door arm 110 may be interposed and coupled between the shaft 137 and the case 120. The lower end portion of the shaft 137 may be formed as a male screw, and an upper end portion 127 of the case 120 may be formed as a female screw. As the lower end portion of the shaft 137 and the upper end portion 127 of the case 120 are screwed, the other end portion of the door arm 110 may be interposed and coupled between the shaft 137 and the case 120.

Accordingly, according to an exemplary embodiment of the present disclosure, an existing door arm opening and closing structure using at least three bearings and applied to a door arm is improved with a structure in which a wheel bearing and a ball bearing assembly are integrated, achieving size reduction and structure simplification.

Furthermore, as the ball bearing that rolls along the bottom wall of the rail is applied, it is possible to reduce noise caused by friction and slip in a curved section.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A sliding door apparatus for a vehicle, the sliding door apparatus comprising:
a door for opening and closing a door opening portion formed in a vehicle body;
a rail;
a door arm including a first end portion connected to an internal side of the door and a second end portion movably engaged to the rail extending in a longitudinal direction of the vehicle body;
a ball bearing assembly provided at the second end portion of the door arm and moving along a path formed by the rail; and
a wheel bearing rotatably provided on an external circumferential surface of the ball bearing assembly and rolling while being in contact with side walls of the rail.

2. The sliding door apparatus of claim 1, wherein the ball bearing assembly includes:
a shaft coupled to a lower portion of the second end portion of the door arm and extending toward a bottom wall of the rail;
a case coupled to a lower end portion of the shaft, wherein the wheel bearing is coupled to an external circumferential surface of the case; and
a main ball bearing protruding from a lower end portion of the case and rolling along the path formed by the rail while being in contact with the bottom wall of the rail.

3. The sliding door apparatus of claim 2, wherein the door arm is connected to the shaft of the ball bearing assembly by riveting or screwing.

4. The sliding door apparatus of claim 2, wherein the ball bearing assembly further includes a damper coupled to the lower end portion of the shaft inside the case and absorbing a shock transferred from the bottom wall of the rail.

5. The sliding door apparatus of claim 4, wherein the ball bearing assembly further includes auxiliary ball bearings provided around the damper inside the case, transferring a load of the door to the damper, and rotating while being in contact with the main ball bearing to rotate the main ball bearing.

6. The sliding door apparatus of claim 2, wherein the shaft and the case are integrated with each other.

7. The sliding door apparatus of claim 2, wherein the case includes a stepped external circumferential surface.

8. The sliding door apparatus of claim 2, wherein the wheel bearing includes:
an internal ring fixedly coupled to an external circumferential surface of the case;
an external ring spaced from the internal ring at a predetermined interval outside the internal ring, rotating around the internal ring, and rolling along the side walls of the rail; and
retaining ball bearings provided between the internal ring and the external ring so that the internal ring and the external ring are spaced from each other at the predetermined interval, and rotating while being in contact with the external ring to rotate the external ring.

9. The sliding door apparatus of claim 8, wherein the wheel bearing further includes an external tire attached to an external circumferential surface of the external ring.

10. The sliding door apparatus of claim 8, wherein the external tire of the wheel bearing rolls while being in contact with the side walls of the rail.

11. The sliding door apparatus of claim 8, wherein the wheel bearing further includes a retainer defining positions of the retaining ball bearings between the internal ring and the external ring.

12. The sliding door apparatus of claim 8, wherein the wheel bearing further includes upper and lower shields covering upper and lower surfaces of the internal ring and the external ring in a direction perpendicular to the side walls of the rail.

13. The sliding door apparatus of claim 1,
wherein the rail includes an upper rail extending in the longitudinal direction of the vehicle body and a lower rail disposed below the upper rail,
wherein the ball bearing assembly moves along an upper surface of the lower rail, and
wherein the wheel bearing rolls while being in contact with side walls of the upper rail.

14. The sliding door apparatus of claim 13, wherein the upper rail includes opposite side walls and an upper wall connecting the side walls, and the wheel bearing rolls while being in contact with the side walls of the upper rail.

15. The sliding door apparatus of claim 13, wherein the second end portion of the door arm is coupled to the ball bearing assembly between the upper rail and the lower rail.

16. The sliding door apparatus of claim 15, wherein the ball bearing assembly includes:
a shaft coupled to an upper portion of the door arm and extending toward the upper rail;
a case coupled to a lower end portion of the shaft; and
a main ball bearing protruding from a lower end portion of the case and rolling along the path formed by the upper rail while being in contact with the upper surface of the lower rail.

17. The sliding door apparatus of claim 15, wherein the lower end portion of the shaft is formed as a male screw, an upper end portion of the case is formed as a female screw, the shaft and the case are screwed, and the second end portion of the door arm is interposed and coupled between the lower end portion of the shaft and the upper end portion of the case.
